(19) United States
(12) Patent Application Publication
(10) Pub. No.: US 2017/0261225 A1
(43) Pub. Date: Sep. 14, 2017

(54) AIR CLEANER

(71) Applicant: WINIX INC., Siheung-si (KR)

(72) Inventors: Chul Min Yoon, Siheung-si (KR); Hee Chul Bae, Ansan-si (KR)

(21) Appl. No.: 15/382,879

(22) Filed: Dec. 19, 2016

(30) Foreign Application Priority Data
Mar. 8, 2016 (KR) 10-2016-0027698

(51) Int. Cl. F24F 13/20; E05D 15/00; F16B 1/00

(52) U.S. Cl. CPC F24F 13/20; F16B 1/00; E05D 15/00; F16B 2001/0035; E05Y 2900/30

(57) ABSTRACT

Provided is an air cleaner including a body; a cover having an intake hole configured to take air in the body; and a detachable member provided to the body and the cover, and configured to detachably apply the cover relative to the body. The detachable member includes a first detachable element provided to the cover; and a second detachable element provided to the body and configured to be detachable with the first detachable element by a magnetic force.

### CROSS-REFERENCE TO RELATED APPLICATION

This application claims the priority benefit of Korean Patent Application No. 10-2016-0027698 filed on Mar. 8, 2016, in the Korean Intellectual Property Office, the disclosure of which is incorporated herein by reference for all purposes.

### TECHNICAL FIELD

One or more example embodiments relate to an air cleaner, and more particular, to an air cleaner of which a cover may be assembled to be easily detachable from a body.

### BACKGROUND

In general, an air cleaner refers to a device that may clean the air by removing any type of dusts and bacteria included in the indoor air and by deodorizing the smell of tobacco, the smell of sweat, etc.

Typically, the air cleaner includes a ventilator configured to take and forcefully ventilate the indoor air and a filtering member configured to filter out the dust or bacteria or to deodorize the smell in the circulating air by driving of the ventilator.

The ventilator includes a motor and a fan configured to take the indoor air in the air cleaner and discharge the air from the air cleaner. The filtering member includes a plurality of filters configured to filter out the dust, bacteria, etc., included in the air through dust collection or to deodorize the smell when the air passes through the inside of the air cleaner by driving of the ventilator.

Currently, with an increasing demand for an air cleaner, various types of developments have been conducted on the air cleaner.

For example, Korean Patent Application No. 10-2009-0033044 filed on Apr. 16, 2009, discloses an air cleaner and an controlling apparatus and method thereof.

### BRIEF SUMMARY

At least one example embodiment provides an air cleaner that may easily assemble a cover to be detachable from a body using a detachable member and may manufacture the detachable member at relatively low cost.

At least one example embodiment also provides an air cleaner that may provide a detachable member so that a body and a cover face each other without being externally exposed, and may improve an aesthetical appearance.

At least one example embodiment also provides an air cleaner that may enhance accessibility to an inside of a body through detachability of a cover, and may easily repair and maintain parts of an air cleaner provided in the body.

According to an aspect of at least one example embodiment, there is provided an air cleaner including a body; a cover having an intake hole configured to take air in the body; and a detachable member provided to the body and the cover, and configured to detachably apply the cover relative to the body. The detachable member includes a first detachable element provided to the cover; and a second detachable element provided to the body and configured to be detachable with the first detachable element by a magnetic force.

The detachable member may further include a support body provided to the cover and configured to support the first detachable element, and the support body includes a plurality of insertion partitions into which both ends of the first detachable element are inserted.

The support body may protrude from an inside of the cover toward the body, and the body may be provided with an insertion groove formed to correspond to a shape of the support body to insert the support body into the body, and the second detachable element may be disposed at a contact position with the first detachable element in the insertion groove.

One side of the plurality of insertion partitions may be open along a lengthwise direction of the first detachable element and the other sides of the plurality of insertions partitions that face the one sides of the plurality of insertion partitions may be closed, so that the first detachable element is inserted into or withdrawn from the plurality of insertion partitions through the open one sides of the plurality of insertion partitions.

The support body may further include a maintain partition provided between the plurality of insertion partitions and configured to support a lower end of the first detachable element, and the maintain partition may include a protrusion configured to protrude toward one side of the first detachable element, so that the first detachable element is fixed to the support body and the first detachable element is separated from the support body by pressing the protrusion.

The maintain partition may be disposed to be above the plurality of insertion partitions, and the first detachable element may be formed to be curved between one of the plurality of insertion partitions and one side of the maintain partition and between another one of the plurality of insertion partitions and the other side of the maintain partition.

The first detachable element may be configured to insert into the plurality of insertion partitions so that a top surface of the first detachable element is disposed to be below top surfaces of the plurality of insertion partitions, and the second detachable element may be configured to protrude from the insertion groove toward the cover.

The first detachable element and the second detachable element may be provided using a magnet, or one of the first detachable element and the second detachable element may be provided using the magnet and the other one of the first detachable element and the second detachable element is provided using metal.

In an air cleaner according to example embodiments, a cover may be assembled to be easily detachable from a body using a detachable member and the detachable member may be manufactured at relatively low cost.

Also, in an air cleaner according to example embodiment, a detachable member may be provided so that a body and a cover face each other without being externally exposed, and may improve an aesthetical appearance.

Also, in an air cleaner according to example embodiment, since accessibility to an inside of a body may be enhanced through detachability of a cover, it is possible to easily repair and maintain parts of an air cleaner provided in the body.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a perspective view of an air cleaner according to an example embodiment;

FIGS. 2A and 2B are perspective views of a detachable member provided to a body and a cover according to an example embodiment; and

FIG. 3 is a cross-sectional view of a detachable member according to another example embodiment.

### DETAILED DESCRIPTION

Hereinafter, some example embodiments will be described in detail with reference to the accompanying drawings. Regarding the reference numerals assigned to the components in the drawings, it should be noted that the same components will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

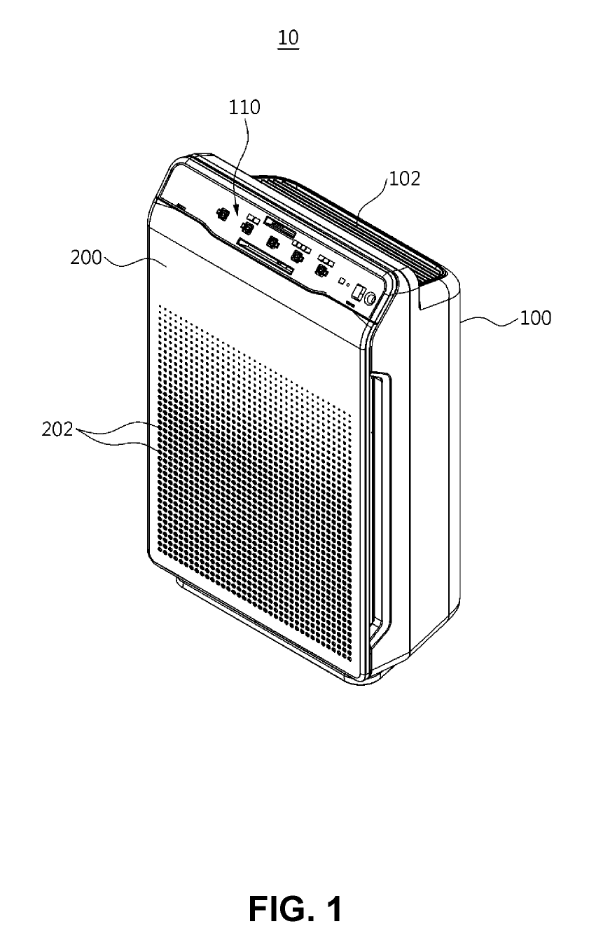

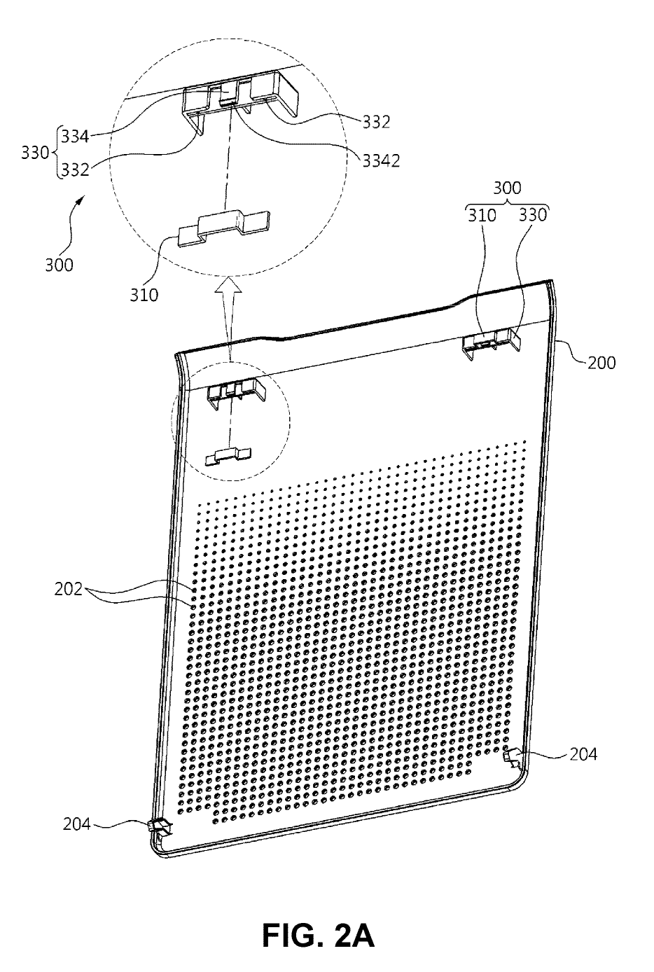

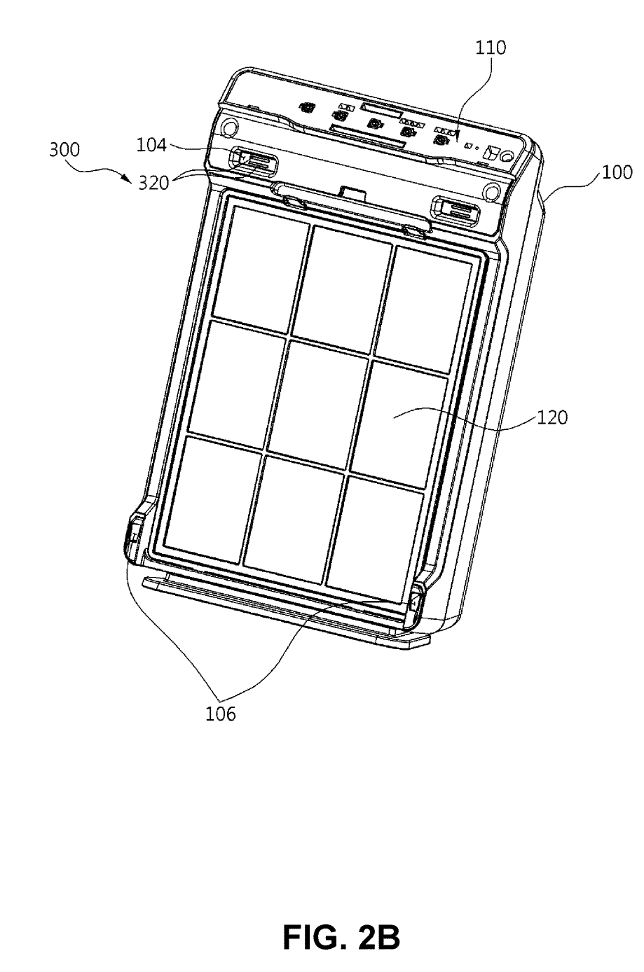

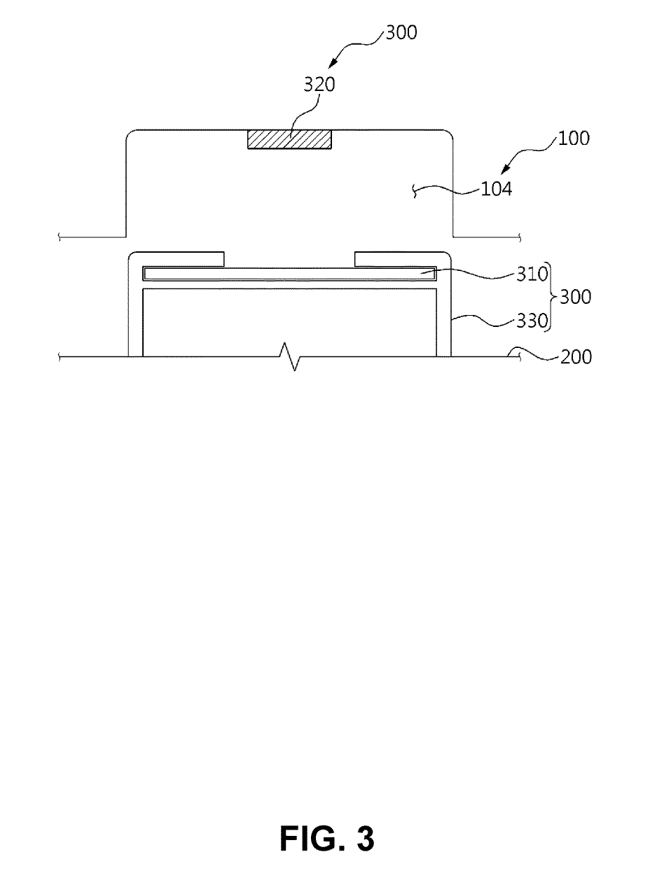

FIG. 1 is a perspective view of an air cleaner according to an example embodiment, FIGS. 2A and 2B are perspective views of a detachable member provided to a body and a cover according to an example embodiment, and FIG. 3 is a cross-sectional view of a detachable member according to another example embodiment.

Referring to FIGS. 1 and 2A and 2B, an air cleaner 10 may include a body 100, a cover 200, and a detachable member 300.

The body 100 may form an appearance of the air cleaner 10.

For example, when the air cleaner 10 is provided as a dehumidifying air cleaner, a heat exchanger (not shown), an air blower (now shown), and a water tank (not shown) may be provided in the body 100.

A shape or a size of the body 100 may vary based on a shape or a size of the heat exchanger, the air blower, and/ or the water tank.

For example, the heat exchanger may include an evaporator and a condenser.

The evaporator may decrease a temperature of the air that passes through the evaporator by evaporating a liquefied refrigerant and by taking the heat from the air around the evaporator. Accordingly, a temperature of the air taken in the body 10 may decrease and condensation or dehumidification water may occur around the evaporator.

The condenser may condense the refrigerant used in the body 100, and may heat the air having passed through the condenser. Here, the condenser may be disposed in a lower class compared to the evaporator in an air blowing path.

Through the heat exchanger in the above structure, the air taken in the body 100 may be cooled while passing through the evaporator whereby moisture or humidity may be removed from the air. Also, the air may be heated while passing through the condenser and may move toward an outlet 102.

In detail, since the outlet 102 is provided on a top surface of the body 100, the air taken in the body 100 through intake holes 202 provided to the cover 200 may move toward the outlet 102 positioned on the top surface of the body 100.

The air blower may include a fan (not shown) and a motor (not shown) disposed to be adjacent to the heat exchanger, and may guide the air dehumidified at the heat exchanger within the body 100 to the outlet 102 provided to the body 100.

Also, the water tank may be disposed in a lower portion of the body 100.

For example, the water tank may be provided to fluidly communicate with the evaporator, and may be configured to collect the dehumidification water produced at the heat exchanger, particularly, the evaporator.

The body 100 may include a controller 110 configured to control an operation of the heat exchanger, the air blower, or the water tank. Using the controller 110, a user may conveniently select whether to operate the heat exchanger, the air blower, or the water tank, and may conveniently control the selected operation.

For example, the user may manually select and operate a desired humidity level or air volume. Also, the air cleaner 10 may detect indoor humidity and automatically operate the detected indoor humidity to reach a desired humidity level.

The cover 200 may be detachably provided to the body 100.

The cover 200 may be provided at the front of the body 100, and may be provided in a shape corresponding to the front of the body 100.

The intake hole 202 configured to take the air in the body 100 may be formed on the cover 200. Accordingly, in a state in which the cover 200 is mounted to the body 100, the air may be taken in the body 100 through the intake holes 202 of the cover 200.

Here, a protective net 120 having an opening (not shown) that disallows a size of a finger to pass may be mounted to the body 100. Accordingly, the user security may be secured and the air taken through the intake holes 202 of the cover 200 may be guided to the inside of the body 100 through the protective net 120.

Meanwhile, once the cover 200 is detached from the body 100, the accessibility to the inside of the body 100 may be enhanced. Thus, it is possible to easily maintain and repair parts of the air cleaner 10 disposed in the body 100.

Referring to FIGS. 2A and 2B, the detachable member 300 may be provided to the body 100 and the cover 200 to detachably assemble the cover 200 relative to the body 100.

The detachable member 300 may include a first detachable element 310 provided to the cover 200 and a second detachable element 320 provided to the body 100.

Here, all of the first detachable element 310 and the second detachable element 320 may be provided using a magnet so that the first detachable element 310 and the second detachable element 320 may be attached to and detached from each other by a magnetic force. For example, an N pole of the first detachable element 310 may be disposed to face an S pole of the second detachable element 320, and an S pole of the first detachable element 310 may be disposed to face an N pole of the second detachable element 320.

Alternatively, one of the first detachable element 310 and the second detachable element 320 may be provided using a magnet, and the other one of the first detachable element 310 and the second detachable element 320 may be provided using a metal.

As described above, if it is possible to easily attach or detach the cover 200 relative to the body 100, any type of materials may be used for the first detachable element 310 and the second detachable element 320.

Hereinafter, an example in which the first detachable element 310 is provided using a metal and the second detachable element 320 is provided using a magnet will be described.

Referring to FIG. 2A, the detachable member 300 may further include a support body 330 provided to the cover 200 and configured to support the first detachable element 310.

The support body 330 may be mounted on an inner surface of the cover 200. The inner surface of the cover 200 refers to a surface on which the cover 200 faces the body 200. Accordingly, the entire detachable member 300 as well as the support body 330 may not be externally exposed.

For example, the support body 330 may include a plurality of insertion partitions 332 into which both ends of the first detachable element 310 are inserted. Accordingly, one end of the first detachable element 310 may be inserted into one insertion partition 332 and the other end of the first detachable element 310 may be inserted into the other insertion partition 332.

Here, one side of the plurality of insertion partitions 332, for example, side toward a lower side of the cover 200 may be open along a lengthwise direction of the first detachable element 310. The other side of the plurality of insertion partitions 332, for example, a side toward an upper side of the cover 200 may be closed.

Accordingly, the first detachable element 310 may be inserted into the support body 330 through the open one sides of the plurality of insertion partitions 332, for example, from the lower side of the cover 200 toward the upper side of the cover 200, and may be withdrawn from the upper side of the cover 200 toward the lower side of the cover 200.

The support body 330 may further include a maintain partition 334 provided between the plurality of insertion partitions 332.

The maintain partition 334 may support a lower end of the first detachable element 310. That is, both ends of the first detachable element 310 may be inserted into the plurality of insertion partitions 332, respectively, and a central portion of the first detachable element 310 may be disposed on the maintain partition 334.

Also, the maintain partition 334 may include a protrusion 3342 configured to protrude toward one side of the first detachable element 310. The protrusion 3342 may be disposed to be adjacent to the open one sides of the plurality of insertion partitions 332 on the maintain partition 334, and may be in contact with one side of the first detachable element 310.

In a state in which the first detachable element 310 is inserted into the plurality of insertion partitions 332, the first detachable element 310 may be fixed to the support body 330 by the protrusion 3342.

By pressing the protrusion 3342, the first detachable element 310 may not be supported by the maintain partition 334 and may be separated from the support body 330. Here, the pressing surface of the protrusion 3342 may be formed as an inclined plane in order to make it easy to press the protrusion 3342.

Meanwhile, the maintain partition 334 may be disposed to be above the plurality of plurality of insertion partitions 332 on the support body 330. A step may be formed between the plurality of insertion partitions 332 and the maintain partition 334. That is, the top surface of the maintain partition 334 may be disposed to be above top surfaces of the plurality of insertion partitions 332.

Accordingly, the first detachable element 310 may be formed to be curved between one of the plurality of insertion partitions 332 and one side of the maintain partition 334, and between another one of the plurality of insertion partitions 332 and the other side of the maintain partition 334.

Also, referring to FIG. 2A, the support body 330 may protrude from the inner surface of the cover 200 toward the body 100. In this case, the body 100 may include an insertion groove 104 formed to correspond to the shape of the support body 330.

Here, the second detachable element 320 may be disposed in the insertion groove 104. In detail, when the support body 330 is inserted into the insertion groove 104, the second detachable element 320 may be disposed at a position at which the second detachable element 320 may contact with the first detachable element 310.

For example, the second detachable element 320 may extend in a widthwise direction of the insertion groove 104. A plurality of second detachable elements 320 may be provided to generate a strong magnetic force against the first detachable element 310.

In addition, an insertion groove 106 is provided at a lower side of the body 100 and an insertion protrusion 204 is provided at a lower side of the cover 200, so that the cover 200 may be fixed relative to the body 100 at the lower side of the body 100 and the cover 200 as well as at the upper side of the body 100 and the cover 200.

Hereinafter, another example of the detachable member 300 will be described with reference to FIG. 3.

Referring to FIG. 3, the support body 300 may not include a maintain partition, and may include the plurality of insertion partitions 332 into which both ends of the first detachable element 310 are inserted. Accordingly, the first detachable element 310 may be provided in a linear shape, instead of being curved.

Here, since the top surface of the first detachable element 310 is disposed to be below the top surface of the support body 330, the second detachable element 320 may be disposed to slightly protrude within the insertion groove 104 of the body 100 to contact with the first detachable element 310.

Accordingly, when the cover 200 is disposed at the front of the body 100, the first detachable element 310 and the second detachable element 320 may be attached to or detached from each other by a magnetic force therebetween.

A shape or a configuration of the detachable member 300 is not limited thereto. Any type of shapes and configurations may be applied if they allow the first detachable element 310 and the second detachable element 320 to be attached to or detached from each other.

The aforementioned detachable member 330 may be applied to various types of devices as well as the air cleaner 10 to assembly the body 100 and the cover 200.

As described above, in an air cleaner according to example embodiments, a cover may be easily assembled to be detachable from a body using a detachable member and the detachable member may be manufactured at relatively low cost. The detachable member may be provided so that the body and the cover face each other without being externally exposed, and may improve an aesthetical appearance. Further, since accessibility to an inside of the body may be enhanced through detachability of the cover, it is possible to easily repair and maintain parts of the air cleaner provided in the body.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An air cleaner comprising:
a body;
a cover having an intake hole configured to take air in the body; and
a detachable member provided to the body and the cover, and configured to detachably apply the cover relative to the body,
wherein the detachable member comprises:
a first detachable element provided to the cover; and
a second detachable element provided to the body and configured to be detachable with the first detachable element by a magnetic force.

2. The air cleaner of claim 1, wherein the detachable member further comprises:
a support body provided to the cover and configured to support the first detachable element, and
the support body comprises a plurality of insertion partitions into which both ends of the first detachable element are inserted.

3. The air cleaner of claim 2, wherein the support body protrudes from an inside of the cover toward the body, and the body is provided with an insertion groove formed to correspond to a shape of the support body to insert the support body into the body, and
the second detachable element is disposed at a contact position with the first detachable element in the insertion groove.

4. The air cleaner of claim 2, wherein one sides of the plurality of insertion partitions are open along a lengthwise direction of the first detachable element and the other sides of the plurality of insertions partitions that face the one sides of the plurality of insertion partitions are closed, so that the first detachable element is inserted into or withdrawn from the plurality of insertion partitions through the open one sides of the plurality of insertion partitions.

5. The air cleaner of claim 2, wherein the support body further comprises a maintain partition provided between the plurality of insertion partitions and configured to support a lower end of the first detachable element, and
the maintain partition comprises a protrusion configured to protrude toward one side of the first detachable element, so that the first detachable element is fixed to the support body and the first detachable element is separated from the support body by pressing the protrusion.

6. The air cleaner of claim 5, wherein the maintain partition is disposed to be above the plurality of insertion partitions, and
the first detachable element is formed to be curved between one of the plurality of insertion partitions and one side of the maintain partition and between another one of the plurality of insertion partitions and the other side of the maintain partition.

7. The air cleaner of claim 3, wherein the first detachable element is configured to insert into the plurality of insertion partitions so that a top surface of the first detachable element is disposed to be below top surfaces of the plurality of insertion partitions, and
the second detachable element is configured to protrude from the insertion groove toward the cover.

8. The air cleaner of claim 1, wherein the first detachable element and the second detachable element are provided using a magnet, or
one of the first detachable element and the second detachable element is provided using the magnet and the other one of the first detachable element and the second detachable element is provided using metal.
